(19) United States
(12) Patent Application Publication
(10) Pub. No.: US 2020/0334644 A1
(43) Pub. Date: Oct. 22, 2020

(54) CLOUD INFORMATION SERVICE-INTEGRATING SYSTEM

(71) Applicant: I.X Co., Ltd., TAIPEI CITY (CN)

(72) Inventors: Tsu-Chin WU, Taipei City (CN); Chih-Ling CHIEN, Taipei City (CN); Yen-Liang CHEN, Taipei City (CN)

(21) Appl. No.: 16/092,197

(22) PCT Filed: Apr. 8, 2016
(86) PCT No.: PCT/CN2016/078786

§ 371 Date: Oct. 8, 2018

(51) Int. Cl. G06Q 20/02; G06F 8/61

(52) U.S. Cl. CPC G06Q 20/02; H04L 67/10; G06F 8/61

(57) ABSTRACT

A cloud information service integration system is provided. A client side uses a computer or a handheld smart communication device to install and prosecute a corresponding application software and then link to a network system of a cloud server for operation of a client side setting step, a service side setting step, a matching step, a search condition adjustment step, a selection step, and a payment step. In the matching step, a matching list is provided to the client side through active matching and manual matching. In the payment step, the client side pays an amount of money to a bank account of the service side or a third party payment account via the network system of the cloud server.

### BACKGROUND OF THE INVENTION

The present invention relates to a cloud information service integration system and, more particularly, to a network system that can be connected to a cloud server through use of a corresponding application software by a client side and that can proceed with a client side setting step, a service side setting step, a matching step, a search condition adjusting step, a selection step, and a payment step as well as its applications.

In modern network business markets, transaction through the cloud network has become more and more popular to the service side and the client side in consumptive behaviors. Electronic business services, such as network shopping, information provision, or networking searching, diversify increasingly. With the increasing demands and the maturity of the third party payment mechanism, the information provision and generation of the service information required during the network business service between the service side and the client side become more important than ever. Thus, providing better network business service is the field endeavored by system program developers.

In the current transaction mechanism of the network markets, if the client side intends to obtain the information of the commodity or service prior to consumption through the network business mechanism, before obtaining the result of the information to be inquired, the client side must spontaneously log in a specific network system to conduct a search of various information and passively enter the keyword of the information the consumer is aware of. However, such a passive open inquiry could not obtain the subjectively desired and expected result or could not find anything if the keyword is not a standard or specific term. Thus, the client side often has to spend considerable time to find out the desired information of the product or service, leading to a considerable waste of time costs.

In another common approach in inquiry and provision of network information on the market, a specific network system interface is provided for the client side to click the command columns on the interface, the network system generates specific information based on the search options, and the specific information is sent to the client side for instant clicking. Alternatively, the client side can proceed with subsequent business transaction after receiving a message and clicking to a desired link.

It is common in a hospital that a doctor cannot handle the schedule, such that the patients cannot receive the expected consultation. The reason could be an unexpected event during a surgery or diagnosis (which takes a longer time) or urgent treatment required in the emergency room or by a critically ill patient. The patients often waste a long time in waiting, which is a waste of time costs. However, conventional appointment systems cannot solve these problems. Most of the patients seeking consultation in a large hospital cannot handle the time properly.

In practice of current network system interfaces, the customers at the client side cannot obtain smart information service that is more active and close to the demands, and the supply end at the service side and the customers at the client side lack open and interactive information exchange. Thus, the conventional network system interfaces cannot improve the commercial transaction service effect to the current technology. With the introduction of the third party payment technology, a need exists for further progress in the conventional network system interfaces.

### BRIEF SUMMARY OF THE INVENTION

In an aspect of the present invention, a cloud information service integration system is provided, wherein a client side uses a computer or a handheld smart communication device to install and prosecute a corresponding application software and then link to a network system of a cloud server for operation. The cloud information service integration system performs the following steps:
a client side setting step: a client proceeds with information setting based on demands of the client, including locations, service types, and expected service time;
a service side setting step: the service side proceeds with setting and logging of products and services provided by the service side, permitting subsequent information matching by the network system of the cloud server;
a matching step: a matching list is provided to the client side through active matching and manual matching, wherein the manual matching includes sending and displaying demands of the client side to the service side by the cloud server, and the service side sends the service side information to the client side via the cloud server;
a search condition adjustment step: the client side changes search conditions if the client side does not accept a matching result of the matching step, the change in the search conditions is fed back to the network system of the cloud server to proceed with re-matching according to the matching step and based on information parameters changed pursuant to a change in the demands;
a selection step: the client side accepts a matching result of the search condition adjustment step and ascertains information of the service side and the time for transaction; and
a payment step: the client side pays an amount of money to a bank account of the service side or a third party payment account via the network system of the cloud server.

The active matching in the matching step can include matching based on the service types provided by the service side within parameter ranges pursuant to a specific distance from a search reference location and a service time of the client side.

The client side can optionally conduct a payment insurance step in the payment step, the payment insurance step includes an insurance contract step, a payment service step, and a paying step,
wherein in the payment contract step, an insurance company insured by the client side acknowledges an insurance contract of the client side, and the service side receives the acknowledgement of the insurance company,
wherein when the payment insurance step is conducted, the network system of the cloud server is linked to a linking mechanism set by the insurance company, and the bank account of the service side or the third party payment account is set and linked,
wherein after the client side confirms transaction in the payment step, the payment service step is carried out via the network system of the cloud server, the insurance company that has completed the insurance contract step pays fee to the bank account of the service side or the third party payment account, accomplishing the paying step.

The payment step can include, after acknowledgement of transaction in an ordering step by the client side, the service side of the transaction proceeds with a payment request step, and the client side carries out an acknowledgement step via the network system of the cloud server after receiving a payment request.

In a second aspect of the present invention, a cloud information service integration system is provided, wherein a client side uses a computer or a handheld smart communication device to install and prosecute a corresponding application software and then link to a network system of a cloud server for operation of a client side setting step, a service side setting step, a demand selection step, a matching step, a search condition adjustment step, a selection step, and a payment step. The client side optionally conducts a payment insurance step in the payment step, and the payment insurance step includes an insurance contract step, a payment service step, and a paying step. In the payment contract step, an insurance company insured by the client side acknowledges an insurance contract of the client side, and the service side receives the acknowledgement of the insurance company. When the payment insurance step is conducted, the network system of the cloud server is linked to a linking mechanism set by the insurance company, and the bank account of the service side or the third party payment account is set and linked. After the client side confirms transaction in the payment step, the payment service step is carried out via the network system of the cloud server, the insurance company that has completed the insurance contract step pays fee to the bank account of the service side or the third party payment account, accomplishing the paying step.

In the client side setting step, the client proceeds with information setting based on demands of the client, including locations, service types, and expected service time.

In the service side setting step, the service side proceeds with setting and logging of products and services provided by the service side, permitting subsequent information matching by the network system of the cloud server.

The matching step can include sending a matching list to the client side through active matching and manual matching. The manual matching can include sending and displaying demands of the client side to the service side by the cloud server. The service side can send the service side information to the client side via the cloud server.

In a third aspect of the present invention, a cloud information service integration system is provided, wherein a client side uses a computer or a handheld smart communication device to install and prosecute a corresponding application software and then link to a network system of a cloud server for making an appointment with a hospital. The cloud information service integration system performs the following steps:
a client side setting step: a client proceeds with information setting based on demands of the client, including locations, types of medical treatment sought by the client, and expected time of appointment;
a service side setting step: the service side, the hospital, proceeds with setting and logging of contents of medical therapy and consulting hours provided by the service side, permitting subsequent information matching by the network system of the cloud server;
a matching step: a matching list is provided to the client side through active matching and manual matching, wherein the manual matching includes sending and displaying demands of the client side to the service side, the hospital, by the cloud server, and the service side sends the service side information to the client side via the cloud server for arranging a sequence of appointment times;
a search condition adjustment step: the client side changes search conditions if the client side does not accept a matching result of the matching step, the network system of the cloud server proceeds with the matching step again;
a selection step: the client side accepts a matching result of the search condition adjustment step and ascertains the appointment including the medical treatment and time of the service side, the hospital;
a time-altering-publishing step: the service side, the hospital, optionally inputs a delay time to the network system of the cloud server to proceed with an appointment time operation to calculate a renewed appointment time for the client side seeking medical treatment; and
a renewed-appointment-time-informing step: the network system of the cloud server informs the client side of news of the renewed appointment time, and the client seeking medical treatment obtains real-time renewed appointment time information via a device connected to the network system.

The present invention will become clearer in light of the following detailed description of illustrative embodiments of this invention described in connection with the drawings.

### DESCRIPTION OF THE DRAWINGS

FIG. 1 is a schematic diagram illustrating an information provision step of an embodiment according to the present invention.

FIG. 2 is a schematic diagram illustrating practice of an embodiment according to the present invention.

FIG. 3 is a schematic diagram illustrating a transaction procedure of an embodiment according to the present invention.

FIG. 4 is a schematic view illustrating another embodiment according to the present invention.

### DETAILED DESCRIPTION OF THE INVENTION

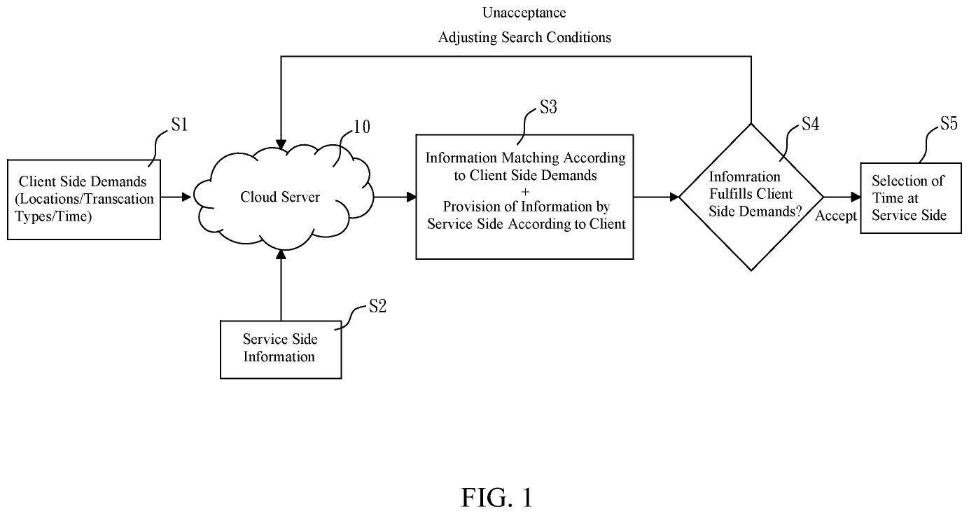

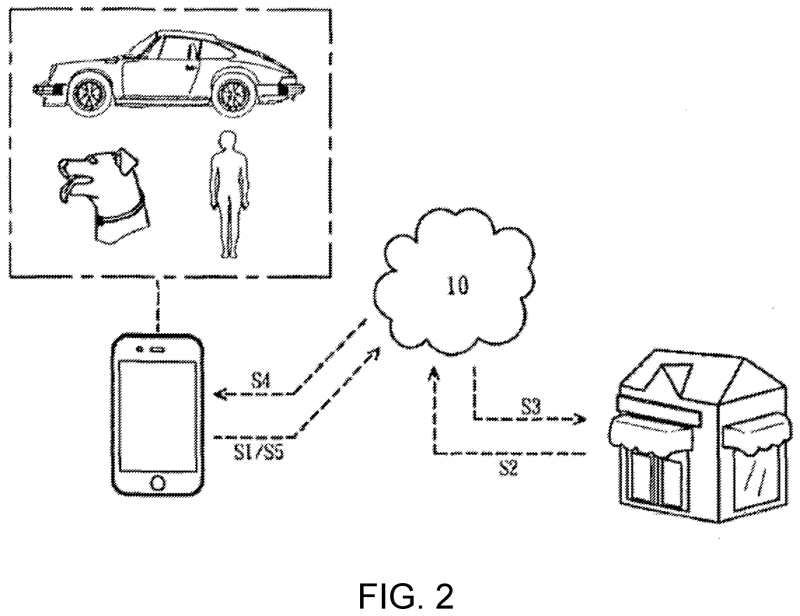

With reference to FIG. 1 and FIG. 2 showing some steps of an embodiment according to the present invention, to provide the consumers of a client side and the supply end of a service side with a better cloud server system and to provide a more open interactive information exchange mechanism, the main technical features of a method according to the present invention includes the following steps: a client side setting step S1, a service side setting step S2, a matching step S3, a search condition adjustment step S4, a selection step S5, a payment step S6, and a payment insurance step S7.

The interface operation design of the network system of the cloud server 10 according to the present invention has two main procedures including a stage of search and provision of information and a stage of ordering and payment. In the stage of search and provision of information, a client side uses a computer or a handheld smart communication device to install and prosecute a corresponding application software and then link to the network system of the cloud server 10, creating an information linkage. After the information linkage is created, the steps shown in FIG. 1 are carried out in the network system of the cloud server 10. The main technique is that the client side setting step S1 is entered after the linkage between the client side information and the network system of the cloud server 10 according to the present invention is created. In the client side setting step S1, a client proceeds with information setting based on demands of the client, including locations, service types, and the expected service time T0. Of course, basic transaction information (including personal information setting) can be included. Thereafter, the network system of the cloud server 10 can proceed with analysis of the information.

The network system of the cloud server 10 according to the present invention also provides operation of the service side setting step S2 after linkage of the information of the supply end of the service side. In the service side setting step S2, the service side proceeds with setting and logging of products and services provided by the service side, such as information of the products or services, business hours, and business locations. The information created after the service side setting step S2 can be used to proceed with subsequent information matching by the network system of the cloud server 10. In steps S1 and S2, the network system of the cloud server 10 provide guiding type and open type information input.

After the above steps S1 and S2, the network system of the cloud server 10 still permits continuous addition and edition of the information from various client sides or service sides. Then, the matching step S3 is carried out. In the matching step S3, after establishment of the new information or edited information by the client sides or the service sides, the network system of the cloud server 10 generates a matching result by analysis and matching of parameter operations based on various information demand inputs set by the client side and the service sides. In an embodiment, the matching step S3 includes active matching. The active matching includes searching service sides located within a query range less than 2 km to a search reference location. The active matching also includes parameter ranges (from T0−x to T0+y) based on the above service time. For example, matching can be made from T0−1 hour to T0+2 hour. Alternatively, if the service side can provide special coordination upon reception of the demands, the manual matching can be sent out. Finally, the result of automatic matching mechanism and the result of manual matching by the business are grouped into a matching list that is sent to the client side. The numeral values are set according to the parameters of each embodiment. The manager of the network system of the cloud server 10 can adjust the parameters according to corresponding demands. In the matching mechanism of the matching step S3, the main technical feature is that, in addition to operation of matching of the network system of the cloud server 10 based on the demands of the client side, the parameter ranges set case by case could result in little option in the matching (such as the service time). In the case of little option or there are other possible demands, the network system of the cloud server 10 can send and display the demands of the client side to the service side. If the client side decides to accept the order or other terms are available (such as another service time), the service side can send the service side information to the client side via the network system of the cloud server 10. Thus, the matching mechanism of the matching step S3 can be more versatile and provides more options.

After the matching step S3, the search condition adjustment step S4 can be optionally carried out. Specifically, if the client side does not accept the matching result of the matching step, the search condition adjustment step S4 can be carried out, and the client side can change the search conditions. The change in the search conditions is fed back to the network system of the cloud server 10 to proceed with re-matching according to the matching step S3 and based on information parameters changed pursuant to the change in the demands.

After completion of the search condition adjustment step S4, the selection step S5 is carried out. The matching list resulting from the matching step S3 or the search condition adjustment step S4 (in which the search conditions are changed) is selected by the client side. For example, after the client side accepts the matching result of the search condition adjustment step S4, the client side ascertains information of the service side and the time for transaction. This mode can be applied in transaction of the market of small objects, providing maneuverability or real time purchase. For example, purchase of pet supplies or sending a pet to an animal hospital can be selected, which is close to the service side information and time for the client side, achieving more accurate transaction.

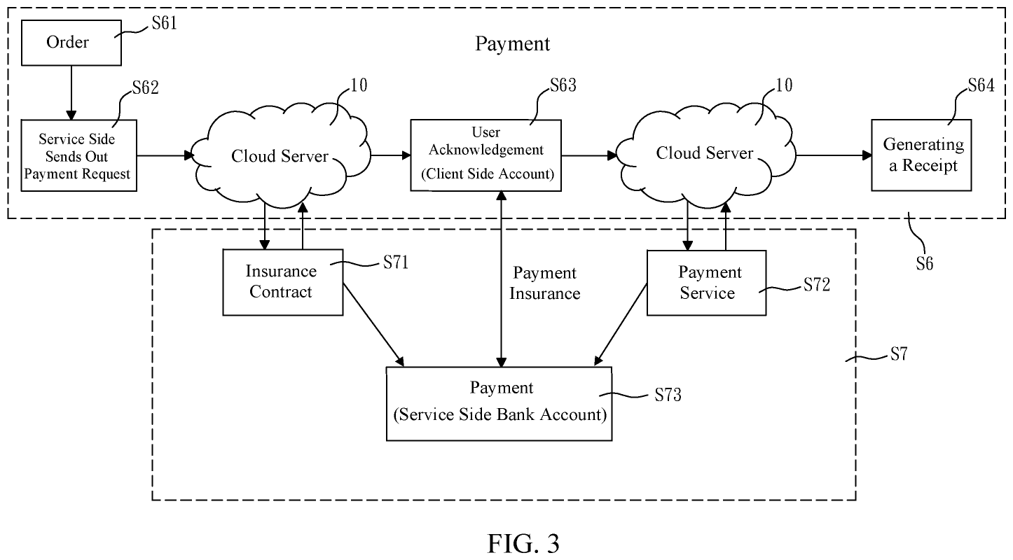

FIG. 3 shows a schematic diagram illustrating a transaction procedure of the an embodiment according to the present invention. After the above steps S1-S5, when the client side and the selected service side undergo a selected transaction, the client side enters the network system of the cloud server 10 to proceed with the payment step S6. In order to further assure the right of the client side in the transaction through a third party payment mechanism and to provide a reliable and rapid transaction procedure, another important technical feature of the present invention is that a payment insurance step S7 can be optionally carried out in the payment step S6. The payment insurance step S7 carried out by the network system of the cloud server 10 includes an insurance contract step S71, a payment service step S72, and a paying step S73. In the payment contract step S71, an insurance company insured by the client side acknowledges an insurance contract of the client side, and the service side receives the acknowledgement of the insurance company. During the payment insurance step S7, the network system of the cloud server 10 is linked to a linking mechanism set by the insurance company, and the bank account of the service side or the third party payment account is set and linked. After the client side confirms the transaction in the payment step S6, the payment service step S72 is carried out via the network system of the cloud server 10. Thus, the insurance company that has completed the insurance contract step S71 pays fee to the bank account of the service side or the third party payment account, accomplishing the paying step S73.

In the optional payment insurance step S7 shown in FIG. 3, a consumer applies for an insurance via the network system of the cloud server 10 or logs in insurance information that has been registered. Furthermore, the insurance number and the client side are tied together in the service provided by the network system of the cloud server 10. The service side must be a business authenticated by the insurance company, saving the time and labor costs if damage claim (related the products or services) occurs. Taking medical service of pets, under the concept of third party payment, when the client side enters the payment step S6 to conduct an ordering step S61 confirming the transaction, the service side in the transaction conducts a payment request step S62. After receiving the payment request, the client side carries out an acknowledgement step S63 via the network system of the cloud server 10. The bank account of the service side or the third party payment account is linked, and the payment service step S72 is carried out via the network system of the cloud server 10. During the payment service step S72, when the payment request is activated, the service side sends electronic transaction information (the insurance number and the electronic certificate of diagnosis) to the insurance company for proceeding with confirmation of claims in the insurance contract step S71. The billable insurance amount can be found in advance. The deductible of this service can be calculated and then sent to the client side for confirmation. Then, the network system of the cloud server 10 activates the claim procedure of the insurance and request payment of the deductible from the client side. The claim amount is paid to the bank account of the service side or the third party payment account to accomplish the paying step S73. If the claim condition in the insurance contract step S71 does not fulfill the terms of the insurance, the customer is charged all of the service fee to accomplish the paying step S73. Thus, transaction safety is assured for both sides of the transaction. Finally, an invoice generation step S64 is conducted to generate a receipt, completing the transaction.

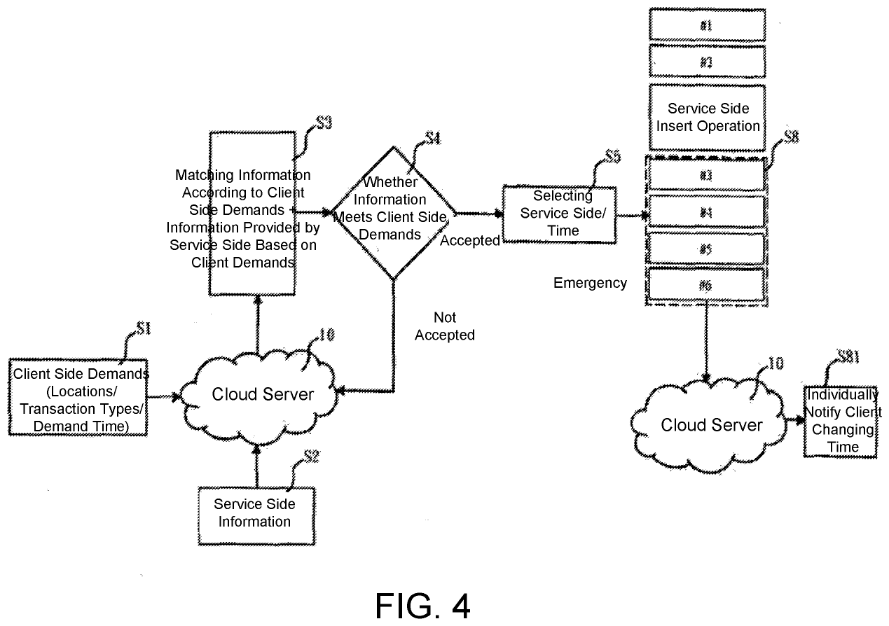

FIG. 4 is a schematic view illustrating another embodiment according to the present invention regarding implementation of search and provision of information. To provide handling of the consulting hours in a hospital, the above steps S1-S5 can be applied in a hospital appointment system, wherein the principles of operation of the client side setting step S1, the service side setting step S2, the matching step S3, the search condition adjusting step S4, and the selection step S5 are substantially the same. When this embodiment is used in the hospital appointment system, in the client side setting step S1, a client proceeds with setting of appointment time with a hospital on the network system of the cloud server 10 based on the demands of the client, thereby proceeding with an appointment with the hospital. Furthermore, the network system of the cloud server 10 permits operation of the service side setting step S2 after linking with the service side information. In the service side setting step S2, setting and logging of the contents of medial therapy and consulting hours provided by the service side are carried out. The information created in the service side setting step S2 can be used by the network system of the cloud server 10 to proceed with the matching step S3 for arranging the sequence of the appointment times. After the matching step S3, the client can optionally proceed with the search condition adjusting step S4 based on acceptance or unacceptance of the matching result. If the client does not accept, the search conditions can be changed, and the network system of the cloud server 10 proceeds with the matching again. If the client accepts the matching information, the selection step S5 is carried out to select the service side and time, accomplishing the selection step S5.

In a case that the doctor encounters an emergency condition or the time of surgery or consulting extends, the service side can conduct a time-altering-publishing step S8 on the network system of the cloud server 10. During this step, the service side, the hospital, inputs a possible delay (delay time) of the doctor at the consulting unit of the hospital to the network system of the cloud server 10 to proceed with an appointment time operation, calculating a renewed appointment time for each client at the client side seeking the medical treatment. After the time-altering-publishing step S8, the network system of the cloud server 10 enters a renewed-appointment-time-informing step S81. During this step, the network system of the cloud server 10 informs the client side of news of the renewed appointment time, and each client seeking medical treatment obtains real-time renewed appointment time information via a device, such as a mobile phone, connected to the network system. The time-altering-publishing step S8 and the renewed-appointment-time-informing step S81 can be optionally repeated at any time.

In view of the foregoing, the operating mechanism of the network system of the cloud server 10 according to the present invention includes the following advantages as compared to the operation of the conventional network transaction platform: 1. By providing active setting and searching of information through the network system of the cloud server 10 and by providing the service side with other service information after understanding each client information through the network system of the cloud server 10, the information generated by the network system of the cloud server 10 is more close to the demands of the client. 2. The third party insurance step can be activated during the transaction to guarantee the transaction and to reduce the time and labor costs. 3. The drawback of poor handling in the appointment time encountered in conventional hospital appointment system is solved, significantly reducing the waste in the time costs.

Although specific embodiments have been illustrated and described, numerous modifications and variations are still possible without departing from the scope of the invention. The scope of the invention is limited by the accompanying claims.

1. A cloud information service integration system, wherein a client side uses a computer or a handheld smart communication device to install and prosecute a corresponding application software and then link to a network system of a cloud server for operation, with the cloud information service integration system performing the following steps:
a client side setting step: a client proceeds with information setting based on demands of the client, including locations, service types, and expected service time;
a service side setting step: the service side proceeds with setting and logging of products and services provided by the service side, permitting subsequent information matching by the network system of the cloud server;
a matching step: a matching list is provided to the client side through active matching and manual matching, wherein the manual matching includes sending and displaying demands of the client side to the service side by the cloud server, and the service side sends the service side information to the client side via the cloud server;
a search condition adjustment step: the client side changes search conditions if the client side does not accept a matching result of the matching step, the change in the search conditions is fed back to the network system of the cloud server to proceed with re-matching according to the matching step and based on information parameters changed pursuant to a change in the demands;
a selection step: the client side accepts a matching result of the search condition adjustment step and ascertains information of the service side and the time for transaction; and
a payment step: the client side pays an amount of money to a bank account of the service side or a third party payment account via the network system of the cloud server.

2. The cloud information service integration system as claimed in claim 1, wherein the active matching in the matching step includes matching based on the service types provided by the service side within parameter ranges pursuant to a specific distance from a search reference location and a service time of the client side.

3. The cloud information service integration system as claimed in claim 1, wherein the client side optionally conducts a payment insurance step in the payment step, the payment insurance step includes an insurance contract step, a payment service step, and a paying step,
wherein in the payment contract step, an insurance company insured by the client side acknowledges an insurance contract of the client side, and the service side receives the acknowledgement of the insurance company,
wherein when the payment insurance step is conducted, the network system of the cloud server is linked to a linking mechanism set by the insurance company, and the bank account of the service side or the third party payment account is set and linked,
wherein after the client side confirms transaction in the payment step, the payment service step is carried out via the network system of the cloud server, the insurance company that has completed the insurance contract step pays fee to the bank account of the service side or the third party payment account, accomplishing the paying step.

4. The cloud information service integration system as claimed in claim 1, wherein the payment step includes, after acknowledgement of transaction in an ordering step by the client side, the service side of the transaction proceeds with a payment request step, and the client side carries out an acknowledgement step via the network system of the cloud server after receiving a payment request.

5. A cloud information service integration system, wherein a client side uses a computer or a handheld smart communication device to install and prosecute a corresponding application software and then link to a network system of a cloud server for operation of a client side setting step, a service side setting step, a demand selection step, a matching step, a search condition adjustment step, a selection step, and a payment step, characterized in that:
the client side optionally conducts a payment insurance step in the payment step, the payment insurance step includes an insurance contract step, a payment service step, and a paying step,
wherein in the payment contract step, an insurance company insured by the client side acknowledges an insurance contract of the client side, and the service side receives the acknowledgement of the insurance company,
wherein when the payment insurance step is conducted, the network system of the cloud server is linked to a linking mechanism set by the insurance company, and the bank account of the service side or the third party payment account is set and linked, and
wherein after the client side confirms transaction in the payment step, the payment service step is carried out via the network system of the cloud server, the insurance company that has completed the insurance contract step pays fee to the bank account of the service side or the third party payment account, accomplishing the paying step.

6. The cloud information service integration system as claimed in claim 5, wherein in the client side setting step, the client proceeds with information setting based on demands of the client, including locations, service types, and expected service time.

7. The cloud information service integration system as claimed in claim 5, wherein in the service side setting step, the service side proceeds with setting and logging of products and services provided by the service side, permitting subsequent information matching by the network system of the cloud server.

8. The cloud information service integration system as claimed in claim 5, wherein the matching step includes sending a matching list to the client side through active matching and manual matching, the manual matching includes sending and displaying demands of the client side to the service side by the cloud server, and the service side sends the service side information to the client side via the cloud server.

9. A cloud information service integration system, wherein a client side uses a computer or a handheld smart communication device to install and prosecute a corresponding application software and then link to a network system of a cloud server for making an appointment with a hospital, with the cloud information service integration system performing the following steps:
a client side setting step: a client proceeds with information setting based on demands of the client, including locations, types of medical treatment sought by the client, and expected time of appointment;
a service side setting step: the service side, the hospital, proceeds with setting and logging of contents of medical therapy and consulting hours provided by the service side, permitting subsequent information matching by the network system of the cloud server;
a matching step: a matching list is provided to the client side through active matching and manual matching, wherein the manual matching includes sending and displaying demands of the client side to the service side, the hospital, by the cloud server, and the service side sends the service side information to the client side via the cloud server for arranging a sequence of appointment times;
a search condition adjustment step: the client side changes search conditions if the client side does not accept a matching result of the matching step, the network system of the cloud server proceeds with the matching step again;
a selection step: the client side accepts a matching result of the search condition adjustment step and ascertains the appointment including the medical treatment and time of the service side, the hospital;
a time-altering-publishing step: the service side, the hospital, optionally inputs a delay time to the network system of the cloud server to proceed with an appointment time operation to calculate a renewed appointment time for the client side seeking medical treatment; and
a renewed-appointment-time-informing step: the network system of the cloud server informs the client side of news of the renewed appointment time, and the client seeking medical treatment obtains real-time renewed appointment time information via a device connected to the network system.

10. The cloud information service integration system as claimed in claim 9, wherein the time-altering-publishing step and the renewed-appointment-time-informing step are optionally repeated.
